(19) United States
(12) Patent Application Publication
(10) Pub. No.: US 2005/0254907 A1
(43) Pub. Date: Nov. 17, 2005

(54) Cutting plate carrier tool with fine adjustment elements

(76) Inventors: Andreas Bader, Siegen-Eisern (DE); Wolfgang Zitzlaff, Kirchheim (DE)

Correspondence Address: FULBRIGHT & JAWORSKI, LLP, 666 FIFTH AVE, NEW YORK, NY, 10103-3198, US

(21) Appl. No.: 10/524,604

(22) PCT Filed: Aug. 8, 2003
(86) PCT No.: PCT/EP03/08851

§ 371 Date: May 25, 2005

(30) Foreign Application Priority Data
Aug. 23, 2002 (DE) 10238808.3

(51) Int. Cl. B26D 1/12

(52) U.S. Cl. 407/36

(57) ABSTRACT

The invention relates to a carrier tool (29) for cutting plates (28) in a cutting tool, wherein the cutting plate (28) is mounted on at least one seat wall in the carrier tool (29) and fine adjustment elements are provided for adjusting the position of the cutting plate (28). In order to improve accuracy of adjustment and further simplify handling, the fine adjustment elements comprise a rotatable adjustment bolt (30) having a surface area configured as a conical surface (32), the conical surface (32) forms a seat wall and the adjustment bolt (30) is arranged in a guide hole (35), said guide hole extending at an angle b relative to the plate seat wall.

The invention relates to a carrier tool for cutting plates in a metal-removing cutting tool in accordance with the preamble of claim 1.

The prior art for fine adjustments of cutting inserts, in this case indexable cutting plates in carrier tools, is generally constituted by adjustment by way of wedges. These have a few known disadvantages in use during machining. For example, when used in rotating milling bodies, these adjusting wedges can change their position as a result of the centrifugal force and thus can also affect the location of the cutting plate. The adjusting wedges must therefore be additionally secured, something which is seldom possible for reasons of space and costs. Moreover, wedge-adjustment is often inaccurate by way of the corresponding contact surfaces and can only be determined dimensionally by the geometry of the wedge with considerable outlay in terms of measurement and adjustment.

The underlying object of the invention is to improve substantially a carrier tool for cutting plates having fine adjustment elements in accordance with the preamble of claim 1 with regard to the accuracy of adjustment and handling.

In accordance with the invention this object is achieved in that the fine adjustment element consists of a rotatable adjustment bolt with a lateral surface that is formed as a conical surface, in that the conical surface forms a plate-seat wall, and in that the adjustment bolt is arranged in a guide bore and this guide bore extends at an angle b in relation to the plate-seat wall.

The lateral surface preferably changes, at the greatest radial extent of the conical surface, into a cylinder surface with the same radial extent, and the diameter of the cylinder surface on the adjustment bolt is equal to the diameter of the guide bore. This cylinder surface takes up the cutting forces in use during machining.

Advantageously, at its one end the adjustment bolt has an external thread or a threaded bore for accurate adjustment.

Expediently, the conical surface has a cone angle a of 1° to 30°, and the angle b is approximately half as large as the angle a.

For fine adjustment of the adjustment bolt, on one end face the adjustment bolt has a slot, hexagon socket, torx or screw drive.

The adjustment bolt is preferably made of hardened steel, hard metal or industrial ceramic material.

Further features of the invention follow from the figures that are described below.

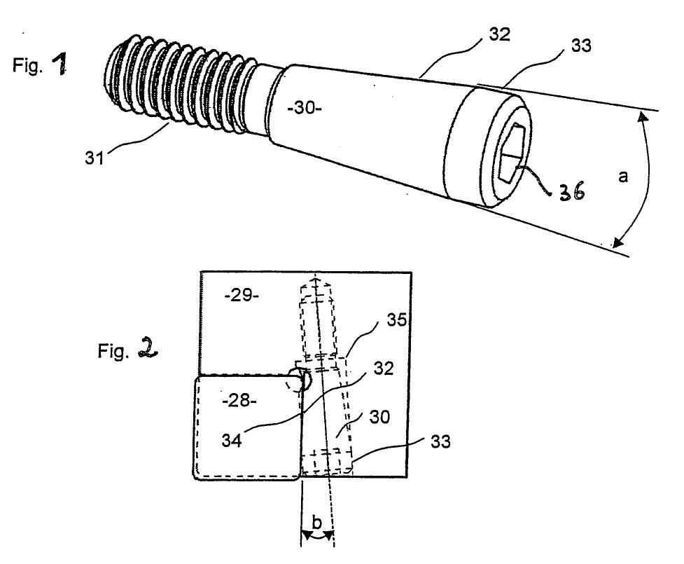

FIG. 1 shows an adjustment bolt 30 in accordance with the invention for fine adjustment. At one end the adjustment bolt 30 has an external thread 31 for securement in the carrier tool 29.

The special feature of this adjustment bolt 30 is the conical surface 32 with a cone angle a of approximately 1° to 30° and the following cylindrical portion or cylinder surface 33.

FIG. 2 shows, in a simplified manner, the plan view of a cutting plate 28 in a carrier tool 29.

The location of the adjustment bolt 30 that is installed as a special feature at an angle b behind the cutting plate 28 can be seen clearly. This angle b is matched to the angle a of the conical surface 32 and has for the most part half the value of the cone angle a.

The conical surface 32 is in contact with the cutting-plate side face 34.

Rotation of the adjustment bolt 30 about its axis in a clockwise direction would shift the cutting plate 28 to the left on account of the guide bore 35 that is arranged at an angle a and the conical surface 32 that is parallel to the cutting plate 28. In this connection, the cylindrical portion or cylinder surface 33 is pushed off the wall of the guide bore 35 and moreover later in use during machining takes up the cutting forces. The cutting plate 28 is of course secured in the carrier tool 29 with suitable means, such as clamping wedges.

Rotation of the adjustment bolt 30 in an anticlockwise direction and manual readjustment of the cutting plate 28 by hand moves the latter back into its starting position again. For ease of rotation of the adjustment bolt 30, a hexagon socket 36 is arranged on the bolt's end face.

By way of the selected size of the angle a and the selected pitch of the external thread 31 it is possible to attain a smaller or coarser adjustment facility and thus more accurate or inaccurate adjustment of the cutting plate 28.

1. A carrier tool for cutting plates in a metal-removing cutting tool, wherein the cutting plate rests against at least one plate-seat wall in the carrier tool, and fine adjustment elements are provided for the adjustment of the position of the cutting plate wherein the fine adjustment element comprises a rotatable adjustment bolt with a lateral surface that is formed as a conical surface, wherein the conical surface forms a plate-seat wall, and in that the adjustment bolt is arranged in a guide bore and this guide bore extends at an angle b in relation to the plate-seat wall.

2. A carrier tool according to claim 1, wherein the lateral surface changes, at the greatest radial extent of the conical surface, into a cylinder surface with the same radial extent.

3. A carrier tool according to claim 2, wherein the diameter of the cylinder surface on the adjustment bolt is equal to the diameter of the guide bore.

4. A carrier tool according to claim 1, wherein at its one end the adjustment bolt has an external thread or a threaded bore.

5. A carrier tool according to claim 1, wherein the conical surface has a cone angle a of 1° to 30°.

6. A carrier tool according to claim 1, wherein the angle b is approximately half as large as the angle a.

7. A carrier tool according to claim 1, wherein for rotation purposes on one end face the adjustment bolt has a slot, hexagon socket, torx or screw drive.

8. A carrier tool according to claim 1, wherein the adjustment bolt is made of hardened steel, hard metal or industrial ceramic material.
